(19) United States
(12) Patent Application Publication
(10) Pub. No.: US 2025/0052265 A1
(43) Pub. Date: Feb. 13, 2025

(54) STRUCTURE AND METHOD FOR ASSEMBLING DIFFERENT TYPES OF METAL PANELS

(71) Applicants: Huyndai Motor Company, Seoul (KR); Kia Corporation, Seoul (KR)

(72) Inventor: Hyun-Sik Kim, Seoul (KR)

(21) Appl. No.: 18/526,563

(22) Filed: Dec. 1, 2023

(30) Foreign Application Priority Data
Aug. 11, 2023 (KR) 10-2023-0105608

(51) Int. Cl. F16B 5/02; F16B 37/06

(52) U.S. Cl. CPC F16B 5/02; F16B 37/061

(57) ABSTRACT

An embodiment structure for assembling different types of metal panels includes a steel panel, a nonferrous panel assembled to the steel panel, a spacing part joined to the steel panel and spacing apart the steel panel from the nonferrous panel, and a flange bolt penetrating the nonferrous panel and fastening the steel panel to the nonferrous panel.

### CROSS-REFERENCE TO RELATED APPLICATIONS

This application claims the benefit of Korean Patent Application No. 10-2023-0105608, filed on Aug. 11, 2023, which application is hereby incorporated herein by reference.

### TECHNICAL FIELD

The present disclosure relates to a structure and method for assembling different types of metal panels.

### BACKGROUND

A vehicle body is typically made of steel. Various panels made of steel are processed into predetermined shapes to manufacture structures or outer panels for a vehicle, and the structures and outer panels are joined by welding. Meanwhile, a component, such as a fender panel, which is highly vulnerable to be damaged, is assembled to the vehicle body by bolting to easily replace it with a new one when damaged.

Therefore, a nonferrous material such as an aluminum alloy is applied to the fender panel to reduce a weight.

As illustrated in FIG. 1 of a related art, a steel panel 111 and a fender panel 112 made of a nonferrous material, which generally constitute the vehicle body, are disposed to overlap each other, and the steel panel 111 and the fender panel 112 are assembled by using a bolt 121 and a nut 123.

However, the steel panel 111 and the fender panel 112 are made of different types of metallic materials, which causes a problem in that galvanic corrosion occurs therebetween because of a potential difference. If moisture penetrates into a portion between the steel panel 111 and the fender panel 112 being joined, galvanic corrosion occurs on a junction surface between the steel panel 111 and the fender panel 112 because of a potential difference on the junction surface.

In order to prevent the galvanic corrosion, a cap 131 made of plastic or rubber is fitted with the bolt 121 to prevent the penetration of moisture.

Alternatively, as illustrated in FIG. 2 of a related art, a portion between the steel panel 111 and the fender panel 112 is coated with wax 132 to prevent the steel panel 111 and the fender panel 112 from being in direct contact with each other.

Because such related arts require that the cap 131 be fitted or the wax 132 be applied, there is a problem in that the number of assembling processes of the steel panel 111 and the fender panel 112 increases, which increases costs.

In addition, in case that the cap 131 is separated from the bolt 121 or a fixing force of the cap 131 decreases as the period of the use elapses, the penetration of moisture occurs on the junction surface, which causes galvanic corrosion thereon. Even when the wax 132 is applied between the steel panel 111 and the fender panel 112, the wax 132 is degraded or eliminated over time. Therefore, the steel panel 111 and the fender panel 112 may come into direct contact with each other, which may facilitate galvanic corrosion therebetween.

### SUMMARY

The present disclosure relates to a structure and method for assembling different types of metal panels. Particular embodiments relate to a structure and method for assembling different types of metal panels of a vehicle body of a vehicle, the structure and method being capable of preventing a junction portion from being corroded.

Accordingly, embodiments of the present disclosure provide a structure and method for assembling different types of metal panels, which are capable of facilitating an assembling process while spacing different types of metal panels so that the metal panels are permanently not in direct contact with one another.

As a preferred embodiment, a structure for assembling different types of metal panels may include a steel panel, a nonferrous panel assembled to the steel panel, a spacing part joined to the steel panel and configured to space apart the steel panel from the nonferrous panel, and a flange bolt configured to penetrate the nonferrous panel and fasten the steel panel and the nonferrous panel.

Screw threads may be respectively formed on inner surfaces of through-holes of the flange bolt and the spacing part, and the flange bolt and the spacing part may be screw-coupled to each other and configured to fasten the nonferrous panel to the steel panel.

A surface of the flange bolt and a surface of the spacing part each may be plated with a zinc component.

The flange bolt may be processed by a coating with zinc and an inorganic binder.

The spacing part may be processed by zinc-nickel plating.

A plurality of welding protrusions may be formed on a bottom surface of the spacing part, and the spacing part may be joined to the steel panel by welding.

A welding seat may be formed on the spacing part and adjoin a welding tool during a welding process.

The welding seat may be formed around a through-hole provided in the spacing part and inclined downward from an upper surface of the spacing part toward the through-hole.

The welding seat may have a predetermined height and be formed around the through-hole provided in the spacing part.

A diameter of a through-hole formed in the nonferrous panel may be larger than an outer diameter of the welding seat of the spacing part.

A diameter of a flange portion of the flange bolt may be larger than a diameter of the through-hole formed in the nonferrous panel.

The spacing part may have a coating hole formed around the through-hole formed in the spacing part so that a coating material flows through the coating hole.

A welding nut may be coupled to a bottom surface of the steel panel by welding, and the flange bolt may penetrate the nonferrous panel, the spacing part, and the steel panel and be fastened to the welding nut, such that the nonferrous panel is assembled to the steel panel.

As another preferred embodiment, a method of assembling different types of metal panels may include a spacing part placement step of placing a spacing part on an upper surface of a steel panel so that a through-hole of the spacing part is matched with a through-hole of the steel panel, a welding step of joining a bottom surface of the spacing part and an upper surface of the steel panel by pressing the spacing part downward from above the spacing part with a welding tool in a state in which a bottom surface of the steel panel is supported by a welding jig, a panel placement step of placing a nonferrous panel on an upper surface of the spacing part so that a through-hole of the nonferrous panel is matched with the through-hole of the spacing part, and a bolt fastening step of assembling the nonferrous panel and the steel panel by fastening a flange bolt.

In the bolt fastening step, the flange bolt may be fastened to the nonferrous panel, the spacing part, and the steel panel and is fastened to a welding nut.

According to the structure and method for assembling different types of metal panels of embodiments of the present disclosure configured as described above, the steel panel, which constitutes the vehicle body, may not be in direct contact with the nonferrous panel such as the fender panel, which makes it possible to prevent galvanic corrosion from occurring on the portion where the different types of metal panels are joined.

In addition, a process of fitting a cap to a bolt or applying wax onto a junction surface between the steel panel and the fender panel to prevent galvanic corrosion may not be required, which makes it possible to simplify the assembling processes and reduce the costs required to manufacture the vehicle.

### BRIEF DESCRIPTION OF THE DRAWINGS

FIG. 1 is an exploded perspective view illustrating an example in which a cap is applied to a bolt in an assembled structure of different types of metal panels in the related art.

FIG. 2 is an exploded perspective view illustrating an example in which a junction surface is coated with wax in an assembled structure of different types of metal panels in the related art.

FIG. 3 is an exploded perspective view illustrating an assembled structure of different types of metal panels according to an embodiment of the present disclosure.

FIG. 4 is a bottom perspective view of a spacing part in the assembled structure of the different types of metal panels according to the embodiment of the present disclosure.

FIG. 5 is a perspective view illustrating a state in which the spacing part is placed on a steel panel in the assembled structure of the different types of metal panels according to the embodiment of the present disclosure.

FIG. 6 is a cross-sectional view illustrating a process of joining the steel panel and the spacing part by welding in the assembled structure of the different types of metal panels according to the embodiment of the present disclosure.

FIG. 7 is a cross-sectional view illustrating a state in which the steel panel and the spacing part are joined by welding in the assembled structure of the different types of metal panels according to the embodiment of the present disclosure.

FIG. 8 is a cross-sectional view illustrating the assembled structure of the different types of metal panels according to the embodiment of the present disclosure.

FIG. 9 is an enlarged cross-sectional view of a main part in FIG. 8.

FIG. 10 is a perspective view illustrating a spacing part in an assembled structure of different types of metal panels according to another embodiment of the present disclosure.

FIG. 11 is a perspective view illustrating a spacing part in an assembled structure of different types of metal panels according to still another embodiment of the present disclosure.

FIG. 12 is a cross-sectional view illustrating an assembled structure of different types of metal panels according to yet another embodiment of the present disclosure.

FIG. 13 is a flowchart illustrating a method of assembling different types of metal panels according to embodiments of the present disclosure.

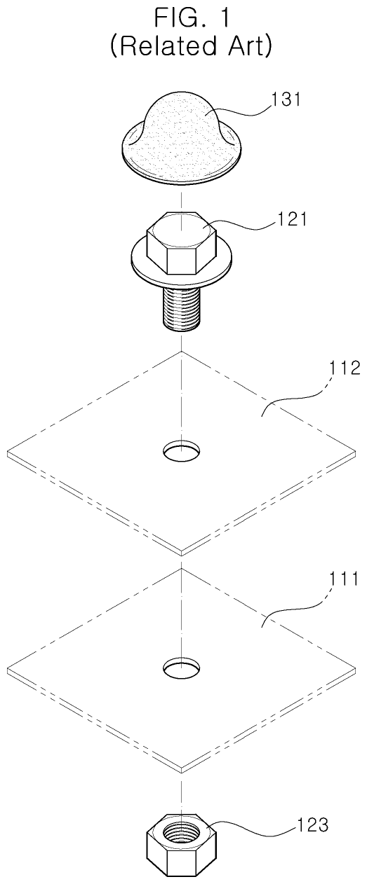

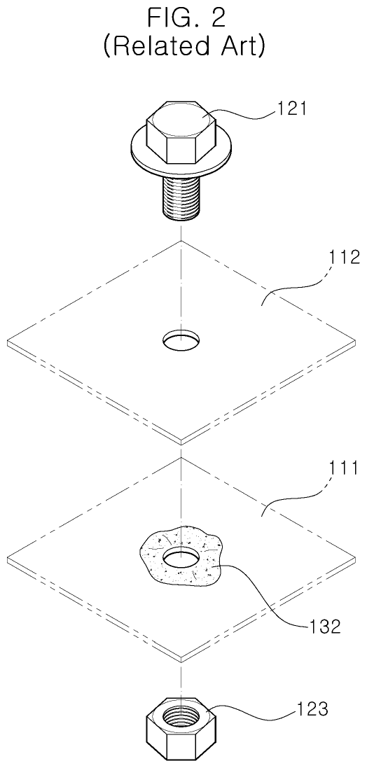

### DETAILED DESCRIPTION OF ILLUSTRATIVE EMBODIMENTS

Hereinafter, embodiments of the present disclosure will be described in detail with reference to the exemplary accompanying drawings, and since these embodiments, as examples, may be implemented in various different forms by those skilled in the art to which the present disclosure pertains, they are not limited to the embodiments described herein.

Hereinafter, a structure and method for assembling different types of metal panels according to embodiments of the present disclosure will be described in detail with reference to the accompanying drawings.

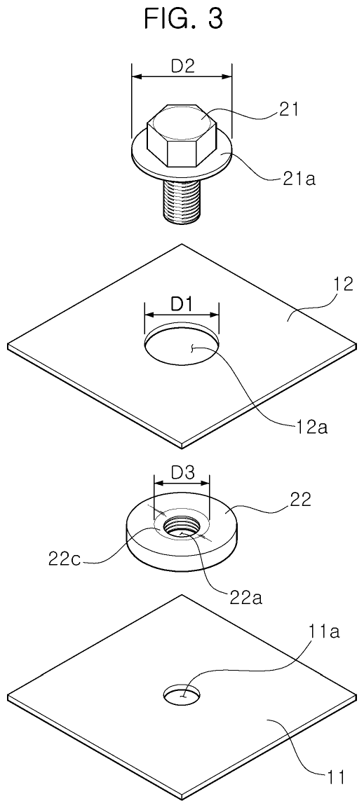

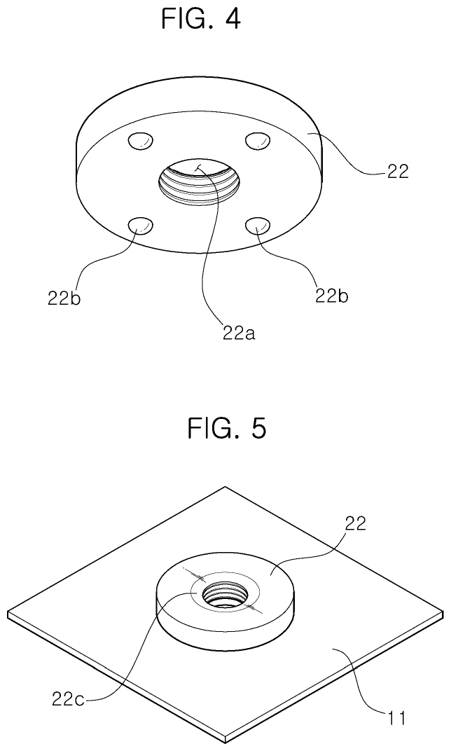

As illustrated in FIG. 3, a structure for assembling different types of metal panels according to an embodiment of the present disclosure may include a steel panel 11, a nonferrous panel 12 assembled to the steel panel 11, a spacing part 22 joined to the steel panel 11 and configured to space apart the steel panel 11 from the nonferrous panel 12, and a flange bolt 21 configured to penetrate the nonferrous panel 12 and fasten the steel panel 11 to the nonferrous panel 12.

The steel panel 11 may define a vehicle body or an outer panel of a vehicle. A through-hole 11a may be formed, preferably, at a center of the steel panel 11, and the flange bolt 21 to be described below may penetrate the through-hole 11a.

The steel panel 11 may be further joined to another adjacent steel panel (not shown) by welding or the like.

The nonferrous panel 12 such as for a fender may be assembled to the steel panel 11 and may define an outer panel of the vehicle. A portion, which is highly likely to be damaged, of the outer panel of the vehicle may be manufactured as the nonferrous panel 12 made of nonferrous metal. A portion, which is less likely to be damaged, may be manufactured as the steel panel 11.

The nonferrous panel 12 may be easy to be replaced with a new one but may not be easily welded to the steel panel 11. Therefore, the nonferrous panel 12 may be assembled to the steel panel 11 by bolting or the like. To this end, the nonferrous panel 12 may have a through-hole 12a to be penetrated and fastened by the flange bolt 21.

The spacing part 22 may be positioned between the steel panel 11 and the nonferrous panel 12 and may space apart the steel panel 11 from the nonferrous panel 12.

The spacing part 22 may have a predetermined height and may be joined to the steel panel 11 by welding or the like, such that the steel panel 11 and the nonferrous panel 12 may be spaced apart from each other by a height of the spacing part 22.

The spacing part 22 may be made of steel. A plurality of welding protrusions 22b may be formed on a bottom surface of the spacing part 22 and used to weld the spacing part 22 to the steel panel 11.

A through-hole 22a, which is penetrated by the flange bolt 21, also may be formed at, preferably, a center of the spacing part 22.

The flange bolt 21 may penetrate the nonferrous panel 12 and may be screw-coupled to the spacing part 22. A screw thread may be formed on an outer peripheral surface of the flange bolt 21, and a screw thread also may be formed on an inner surface of the through-hole 22a of the spacing part 22, such that the flange bolt 21 is fastened to the spacing part 22, and the steel panel 11 and the nonferrous panel 12 are assembled together.

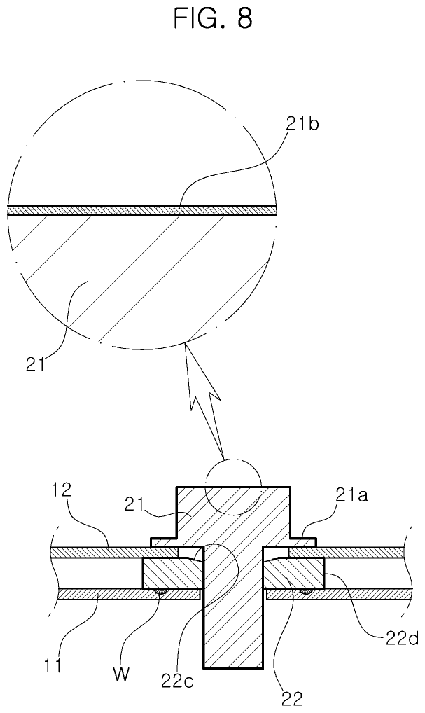

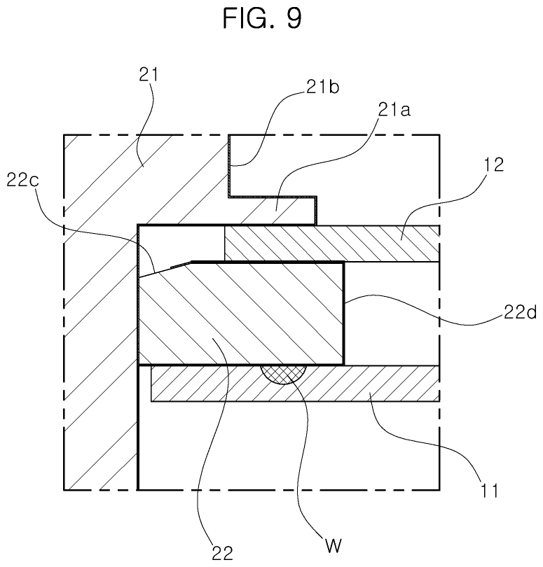

As illustrated in FIG. 8, a flange portion 21a may be formed on a head of the flange bolt 21 so that the flange portion 21a presses an upper surface of the nonferrous panel 12 when the flange bolt 21 is completely fastened to the steel panel 11. A diameter D2 of the flange portion 21a of the flange bolt 21 may be larger than a diameter D1 of the through-hole 12a formed in the nonferrous panel 12.

A surface of the flange bolt 21 and a surface of the spacing part 22 may be plated with a zinc component, such that the corrosion resistance of the flange bolt 21 and the spacing part 22 is improved.

That is, a surface of the flange bolt 21 may be treated by a coating with zinc and an inorganic binder, as is well-known in the art, such that a plating layer 21b is formed on the surface of the flange bolt 21. The coating may use a plating solution which includes no harmful heavy metal, such as chromium, and may provide excellent corrosion resistance. Therefore, the coating may be applied to the flange bolt 21, thereby preventing corrosion between the flange bolt 21 and another member adjacent to the flange bolt 21. An example of such a coating is Geomet®, which is composed of zinc and aluminum flakes passivated in a binder in which a lubricant has been integrated. Geomet® is water-based, chrome-free and nonylphenol-free.

In addition, a surface of the spacing part 22 may be plated by zinc-nickel plating, such that a plating layer 22d is formed on the surface of the spacing part 22. The zinc-nickel plating may provide excellent weldability, such that the spacing part 22 may be easily joined to the steel panel 11 when the spacing part 22 is joined to the steel panel 11 by welding.

Meanwhile, the spacing part 22 may have a welding seat 22c, which adjoins a welding tool 32, at the time of joining the spacing part 22 to the steel panel 11 by welding.

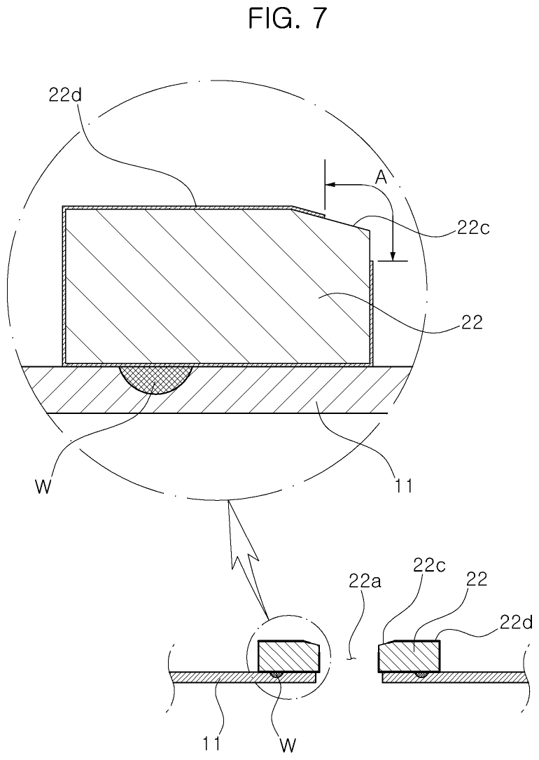

The welding seat 22c may be formed around the through-hole 22a of the spacing part 22 and may be inclined downward toward a center of the through-hole 22a from an upper surface of the spacing part 22. During the welding process, the spacing part 22 may be pressed by the welding tool 32, and the plating layer 22d on the surface of the spacing part 22 may be partially separated. Therefore, the welding seat 22c may be formed concavely so that a portion (see section A in FIG. 7) of the spacing part 22, where the plating layer 22d is not provided, may not adjoin the bottom surface of the nonferrous panel 12.

In addition, the diameter D1 of the through-hole 12a of the nonferrous panel 12 may be larger than an outer diameter D3 of the welding seat 22c of the spacing part 22. Because the through-hole 12a of the nonferrous panel 12 is formed to be larger than the welding seat 22c, the portion (see section A in FIG. 7), where the plating layer 22d is not provided, may be prevented from being in direct contact with the nonferrous panel 12 even though the plated portion of the welding seat 22c is separated.

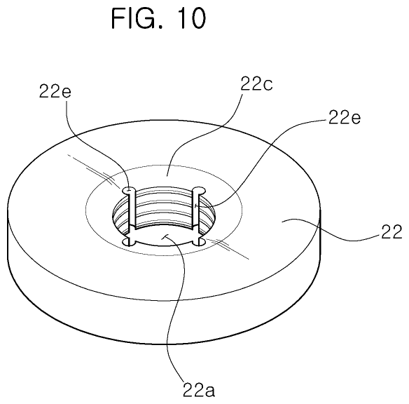

FIG. 10 illustrates another embodiment of the present disclosure in which coating holes 22e may be formed in the through-hole 22a of the spacing part 22. The coating holes 22e may be formed in the through-hole 22a of the spacing part 22 and disposed along the through-hole 22a, such that a coating material may easily flow through the coating holes 22e during a coating process such as electrocoating. Therefore, the coating performance may be improved.

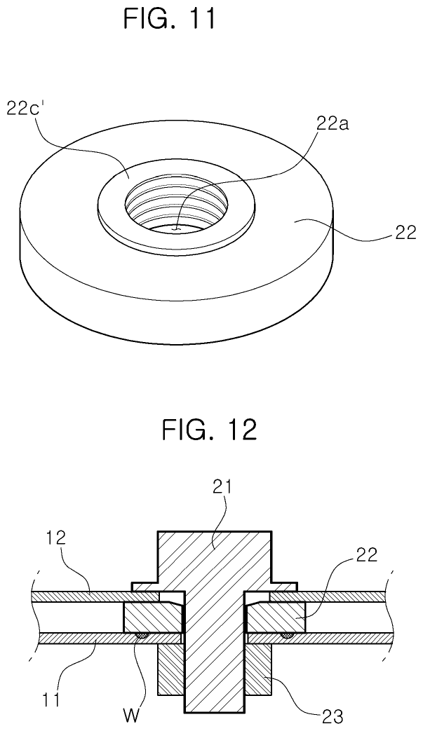

FIG. 11 illustrates another embodiment of the present disclosure in which the welding seat 22c formed on the spacing part 22 may protrude upward from the spacing part 22 by a predetermined height. That is, a welding seat 22c′ in FIG. 11 may have a predetermined height and may be formed around the through-hole 22a formed in the spacing part 22. Even though the welding seat 22c′ protrudes upward from the spacing part 22, the welding seat 22c′ may not be in contact with the nonferrous panel 12 because a diameter of the welding seat 22c′ is smaller than the diameter D1 of the through-hole 12a of the nonferrous panel 12.

In this case, a height of the welding seat 22c′ may be smaller than a thickness of the nonferrous panel 12. If the height of the welding seat 22c′ is larger than the thickness of the nonferrous panel 12, the flange portion 21a of the flange bolt 21 cannot press the nonferrous panel 12 when the nonferrous panel 12 is fastened by the flange bolt 21. Therefore, the height of the welding seat 22c′ may be smaller than the thickness of the nonferrous panel 12.

FIG. 12 illustrates a structure for assembling different types of metal panels according to another embodiment of the present disclosure.

In this embodiment, the spacing part 22 may be formed in a washer shape, and no screw thread may be formed in the through-hole 22a of the spacing part 22.

A welding nut 23 having a screw thread formed therein may be additionally coupled to the bottom surface of the steel panel 11, e.g., joined to the bottom surface of the steel panel 11 by welding, and the flange bolt 21 may be fastened to the welding nut 23.

Therefore, the flange bolt 21 may penetrate the nonferrous panel 12, the spacing part 22, and the steel panel 11 and may be fastened to the welding nut 23, such that the nonferrous panel 12 is assembled to the steel panel 11.

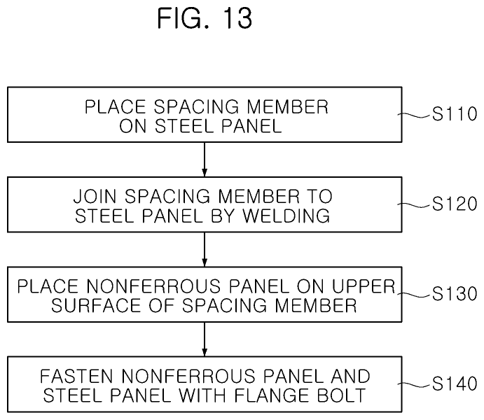

FIG. 13 illustrates a method of assembling different types of metal panels according to embodiments of the present disclosure.

The method of assembling different types of metal panels according to embodiments of the present disclosure may include a spacing part placement step S110 of placing the spacing part 22 on the upper surface of the steel panel 11 so that the through-hole 22a of the spacing part 22 is matched with the through-hole 11a of the steel panel 11, a welding step S120 of joining the bottom surface of the spacing part 22 and the upper surface of the steel panel 11 by pressing the spacing part 22 downward from above the spacing part 22 with the welding tool 32 in a state in which the bottom surface of the steel panel 11 is supported by a jig 31, a panel placement step S130 of placing the nonferrous panel 12 on the upper surface of the spacing part 22 so that the through-hole 12a of the nonferrous panel 12 is matched with the through-hole 22a of the spacing part 22, and a bolt fastening step S140 of assembling the nonferrous panel 12 and the steel panel 11 by fastening the flange bolt 21.

In the spacing part placement step S110, the spacing part 22 may be placed on the upper surface of the steel panel 11. That is, the spacing part 22 may be placed on the upper surface of the steel panel 11 so that the through-hole 22a of the spacing part 22 is matched with the through-hole 11a of the steel panel 11 (see FIG. 5).

In the welding step S120, the spacing part 22 and the steel panel 11 may be joined by welding. The bottom surface of the spacing part 22 and the upper surface of the steel panel 11 may be joined by pressing the spacing part 22 downward from above the spacing part 22 with the welding tool 32 in the state in which the bottom surface of the steel panel 11 is supported by the jig 31. The welding protrusion 22b may be melted (W in FIG. 7), such that the steel panel 11 is joined to the spacing part 22.

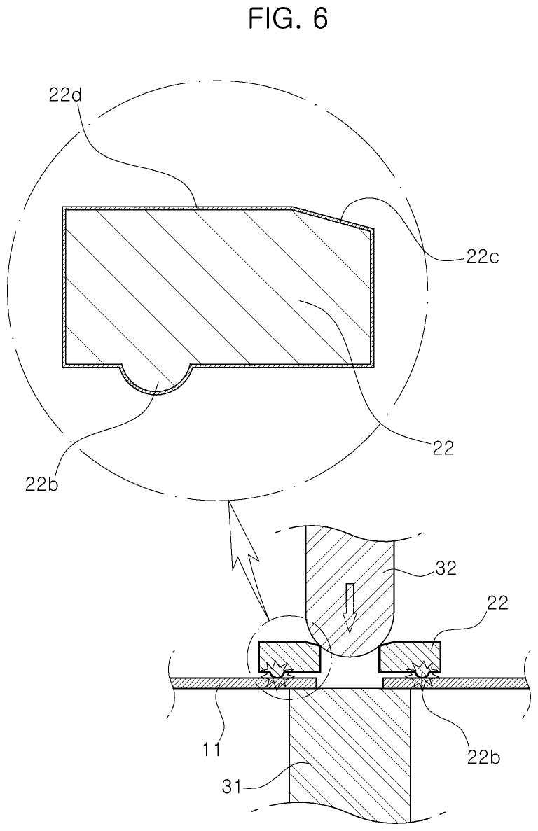

The plating layer 22d may be formed on the entire surface of the spacing part 22 (see FIG. 6), but the welding tool 32 may press the welding seat 22c in the welding step S120. In this case, the plating layer 22d may be separated from the portion pressed by the welding tool 32, such that the plating layer 22d is not formed in a partial region (section A in FIG. 7).

In the panel placement step S130, the nonferrous panel 12 may be positioned on the upper surface of the spacing part 22. In the panel placement step S130, the nonferrous panel 12 may be placed on the upper surface of the spacing part 22 so that the through-hole 12a of the nonferrous panel 12 is matched with the through-hole 22a of the spacing part 22.

In the bolt fastening step S140, the nonferrous panel 12 and the steel panel 11 may be assembled by fastening the flange bolt 21 to the welding nut 23. In the bolt fastening step S140, the flange bolt 21 may penetrate the nonferrous panel 12 and may be fastened to the spacing part 22 and the welding nut 23, such that the nonferrous panel 12 is assembled to the steel panel 11.

The plating layer 22d may be separated from a partial section of the spacing part 22 in the welding step S120, but the plating layer 21b may be formed on the entire surface of the flange bolt 21. Therefore, as illustrated in FIG. 8, the nonferrous panel 12 may adjoin the plating layer 21b of the flange bolt 21 and the plating layer 22d of the spacing part 22 in the state in which the nonferrous panel 12 is spaced apart from the steel panel 11. Therefore, it is possible to prevent galvanic corrosion from occurring between the nonferrous panel 12 and the steel panel 11.

What is claimed is:

1. A structure for assembling different types of metal panels, the structure comprising:
a steel panel;
a nonferrous panel assembled to the steel panel;
a spacing part joined to the steel panel and spacing apart the steel panel from the nonferrous panel; and
a flange bolt penetrating the nonferrous panel and fastening the steel panel to the nonferrous panel.

2. The structure of claim 1, wherein screw threads are respectively formed on inner surfaces of through-holes of the flange bolt and the spacing part such that the flange bolt and the spacing part are screw-coupled to each other to fasten the nonferrous panel to the steel panel.

3. The structure of claim 1, wherein a surface of the flange bolt and a surface of the spacing part are each plated with a zinc component.

4. The structure of claim 3, wherein the flange bolt is processed by a coating with zinc and an inorganic binder.

5. The structure of claim 1, wherein the spacing part is processed by zinc-nickel plating.

6. The structure of claim 1, further comprising a plurality of welding protrusions disposed on a bottom surface of the spacing part, wherein the spacing part is joined to the steel panel by welds.

7. The structure of claim 6, further comprising a welding seat disposed on the spacing part and configured to be adjoined to a welding tool during a welding process.

8. The structure of claim 7, wherein the welding seat is disposed around a through-hole in the spacing part and is inclined downward from an upper surface of the spacing part toward the through-hole.

9. The structure of claim 7, wherein the welding seat has a predetermined height and is disposed around a through-hole in the spacing part.

10. The structure of claim 1, wherein a diameter of a through-hole in the nonferrous panel is larger than an outer diameter of a welding seat of the spacing part.

11. The structure of claim 1, wherein a diameter of a flange portion of the flange bolt is larger than a diameter of a through-hole in the nonferrous panel.

12. The structure of claim 1, wherein a coating hole is disposed around a through-hole in the spacing part, wherein a coating material is configured to flow through the coating hole during a coating process.

13. The structure of claim 1, further comprising a welding nut coupled to a bottom surface of the steel panel, wherein the flange bolt penetrates the nonferrous panel, the spacing part, and the steel panel and is fastened to the welding nut, such that the nonferrous panel is assembled to the steel panel.

14. A method of assembling different types of metal panels, the method comprising:
placing a spacing part on an upper surface of a steel panel so that a through-hole of the spacing part is matched with a through-hole of the steel panel;
joining a bottom surface of the spacing part and the upper surface of the steel panel by pressing the spacing part downward from above the spacing part with a welding tool in a state in which a bottom surface of the steel panel is supported by a welding jig;
placing a nonferrous panel on an upper surface of the spacing part so that a through-hole of the nonferrous panel is matched with the through-hole of the spacing part; and
assembling the nonferrous panel and the steel panel by fastening a flange bolt.

15. The method of claim 14, wherein assembling the nonferrous panel and the steel panel comprises fastening the flange bolt to the nonferrous panel, the spacing part, the steel panel, and a welding nut disposed below the steel panel.

16. The method of claim 14, wherein a surface of the flange bolt and a surface of the spacing part are each plated with a zinc component.

17. The method of claim 16, wherein the flange bolt is processed by a coating with zinc and an inorganic binder.

18. The method of claim 14, wherein the spacing part is processed by zinc-nickel plating.

19. The method of claim 14, wherein a plurality of welding protrusions is disposed on the bottom surface of the spacing part, and wherein the spacing part is joined to the steel panel by welding.

20. The method of claim 14, wherein a welding seat is formed with a predetermined height around the through-hole in the spacing part and adjoins the welding tool during a welding process.
